(19) United States
(12) Patent Application Publication
(10) Pub. No.: US 2003/0010697 A1
(43) Pub. Date: Jan. 16, 2003

(54) Filter device

(76) Inventors: Norbert Sann, Riegelsberg (DE); Volkmar Klein, Zweibrucken (DE); Jurgen Sticher, Bexbach (DE)

Correspondence Address: Mark S Bicks, Roylance Abrams Berdo & Goodman, Suite 600, 1300 19th Street NW, Washington, DC, 20036, US

(21) Appl. No.: 10/203,514

(22) PCT Filed: Feb. 8, 2001
(86) PCT No.: PCT/EP01/01350

(30) Foreign Application Priority Data
Feb. 12, 2000 (DE) 100 06 327.6

(51) Int. Cl. B01D 35/16

(52) U.S. Cl. 210/234; 210/248; 210/430; 210/450; 210/407; 210/452

(57) ABSTRACT

The invention relates to a filter device comprising at least one filter element (32), which can be accommodated inside a filter housing (22). Said filter device also comprises an inlet (16) for a fluid to be cleaned and an outlet (18) for the fluid cleaned by the filter element (32), whereby the filter element (32) is retained by at least one element retainer (106) of the filter housing (22). By virtue of the fact that a closing device (98) seals the interior (34) of the filter element (32) off from the environment when the filter element (32) is removed from the element retainer (106), a filter device is created which is improved with regard to the prior art and which, in particular, simplifies the necessary exchange of the filter element while imposing only a slight burden on the environment.

The invention relates to a filter device with the features of the preamble of claim 1.

Pertinent filter devices (DE-A-195 11 450) are known in a host of embodiments and are freely available on the market. If the filter element has been fouled after a certain length of use depending on the filtration task to be performed, it can be replaced by a new filter element, for the pertinent filter element replacement the filter housing generally having to be vented and opened and its being closed again after the filter element has been replaced. In doing so fouled fluid often remains within the otherwise added filter element, and when disposing of the filter element contaminated fluid can unintentionally emerge due to spillage; this burdens the environment and necessitates the corresponding clean-up. Furthermore, when the element is changed the fouled filter element is often completely filled on its inside with residual fluid; this leads to a clearly perceptible increase in the weight to be handled for the filter element which is to be replaced and makes more work for the maintenance personnel.

In a known filter assembly approach as claimed in DE-A-195-11 450 the closing element is formed from a spring-loaded plate valve part which, in the manner of a check valve which is closed in normal operation, opens in the case of an excess pressure rise in the filter housing and directly establishes a connection to a fouled fluid intake line so that in the case of a used filter element for purposes of a bypass approach a“short circuit” is formed and the pump delivers directly from the clean fluid side to the dirty fluid side (circulation). This prevents the dirty fluid from traveling unfiltered into the hydraulic reservoir; depending on the pressure conditions prevailing on the check valve, malfunctions cannot always be precluded.

DE-A-197 17 054 discloses a generic filter device, especially a water tank with a filter cartridge. The water tank is provided with a filter cartridge which on its outlet area has a valve with a closing element. The tank is inserted into a beverage machine (coffee vending machine or the like), the valve with its ball closing element being opened by a plug which is not shown in the beverage machine by means of pressure on the closing element in the form of a closing ball. The pump of the beverage machine can then intake water if necessary by way of the valve for further use and as a result of the low water entry opening of the outer filter screen of the filter cartridge the water tank can be completely emptied by the indicated pump. Therefore the water is conditioned in the conventional approach advantageously in an ascending current so that bed compaction, such as channeling, is avoided. By means of a filter screen located in the tip of the cartridge the latter can be automatically vented. Alternatively the check valve which can be mechanically opened by way of the plug can likewise be mounted in the filter cartridge, in both cases the closing element of the valve being guided in a retainer. Since the opening plug with the correspondingly small transfer cross section opens the closing element of the valve, malfunctions cannot be precluded here either. Since when the water tank is removed, the closing element closes by way of the closing spring, some portions of fluid remain in the water tank and/or in the filter cartridge so that when the known design is transferred to a hydraulic application the aforementioned disadvantages arise, specifically that when the element is changed the fouled filter element on its inside remains filled with the remaining fouled fluid in a disadvantageous manner.

Proceeding from this prior art, the object of the invention is to devise an improved filter device which in particular facilitates the necessary changing of the filter element and burdens the environment less. This object is achieved by a filter device with the features of claim 1.

By virtue of the fact that according to the characterizing part of claim 1 for fluid supply of the fluid drain both the retainer and also the opening part have passages for the fluid located in the interior of the filter element, for changing of the filter element the residual fouled fluid remaining within the element can be drained out of the filter element by way of the fluid drain and thus by way of the passages from the retainer and also by way of the opening part as parts of the sealing device and with the closing of the sealing device when the fouled filter element is replaced it is ensured that fluid draining further to the inside cannot emerge from the filter element into the environment. In this way the environment is not polluted and additional clean-up can be eliminated. Since the filter element is no longer filled with fouled fluid when the element is replaced as a result of the sealing device, it can also be handled and replaced more easily due to the lighter weight. This greatly facilitates the work of maintenance personnel.

With the approach as claimed in the invention it is ensured that the sealing device is automatically closed by itself without further handling processes, as soon as the filter element is removed from the element receptacle of the filter housing. Preferably the closing element is a closing ball which is under the action of a compression spring as the energy storage device which, held together with the closing ball in a retainer, is a component of the bottom part of the filter element, which component projects into the interior of the filter element.

In another especially preferred embodiment of the filter device as claimed in the invention the filter element has a supporting body and a filter mat body which can be separated from one another, the sealing device being a component of the filter mat body. In this way only the filter mat body which has actually been fouled need be disposed of or recycled, whereas the other parts of the filter element can be re-used. This saves resources and if the filter mat body consists of a suitable material it can be completely incinerated, because of the minimal environmental impact. Since the sealing device is a component of the filter mat body which is to be disposed of, care is preferably taken that it likewise consists of recyclable material or material which can be easily disposed of.

In another especially preferred embodiment of the filter device as claimed in the invention, the filter housing has a support ring for the filter element which can be detachably joined to the filter housing by way of a quick release connecting means. Preferably the support ring is provided with a stripping means which when the filter element is removed scrapes along its outside periphery. The quick release connecting means enables quick separation of the filter element from the filter housing for a disposal process; this in turn relieves maintenance personnel. By way of the stripping means it is ensured that dirt even in the form of contaminated fluid which may remain on the outside periphery of the filter element is also stripped off during the replacement process and remains in the filter housing for a later cleaning process by way of the new inserted filter element.

Other advantageous embodiments are the subject matter of the dependent claims.

The filter device as claimed in the invention is detailed below using one embodiment as shown in the drawings which are schematic and not drawn to scale.

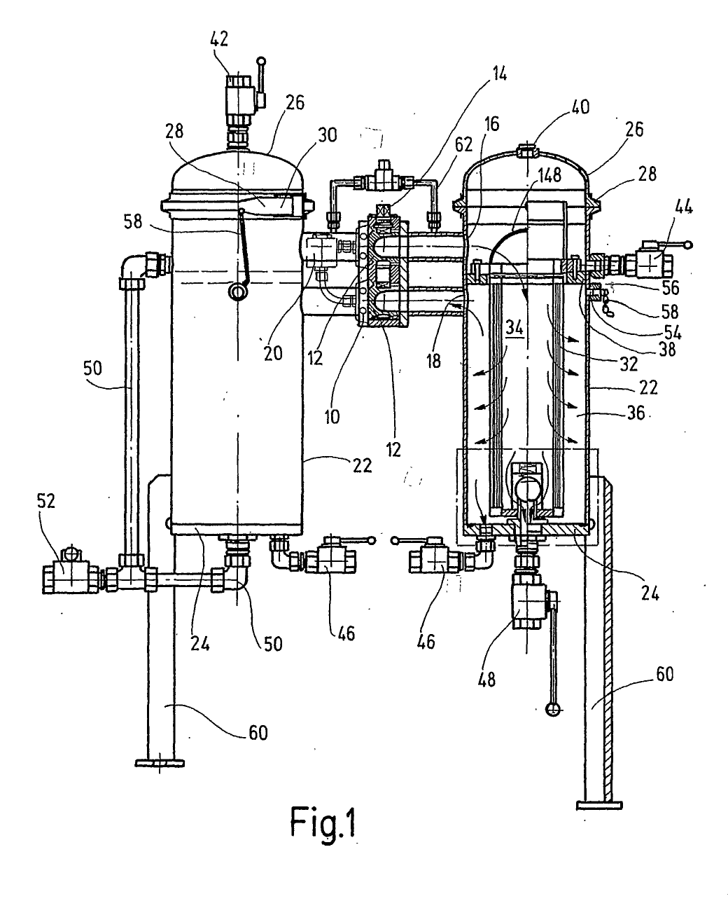

FIG. 1 shows partially in an aspect, partially in a section a filtration system using the filter device as claimed in the invention;

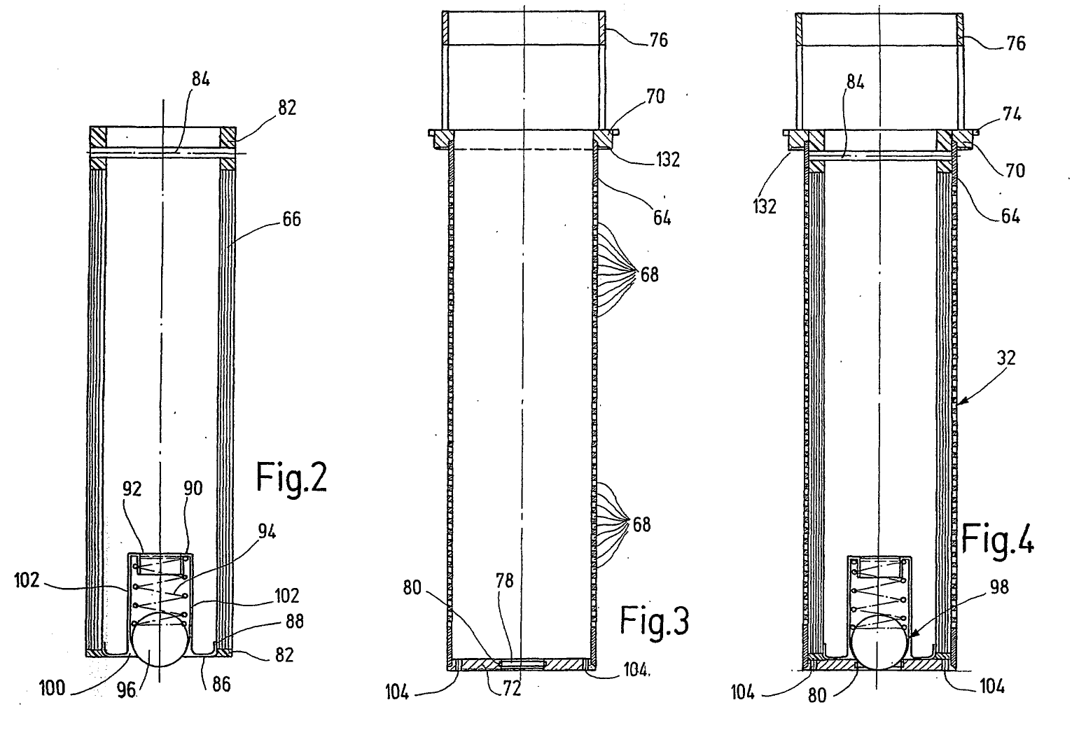

FIGS. 2 to 4 show partially in an aspect and partially in a section the filter mat body, the supporting body, and the filter element composed of the filter mat body and the support body;

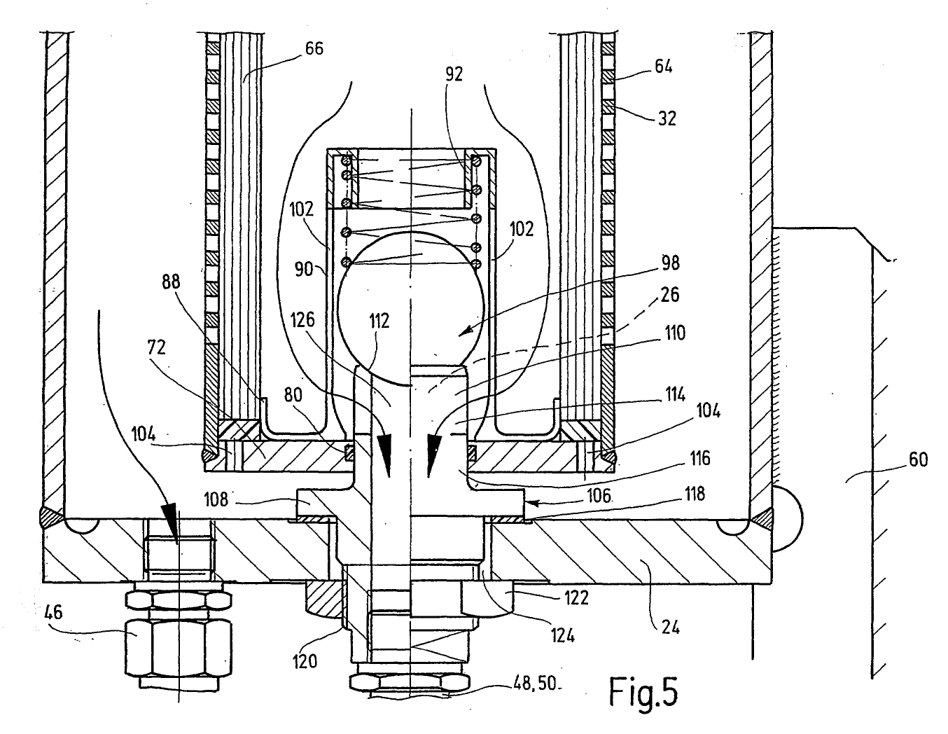

FIG. 5 shows an enlarged detail of the bottom end of the filter device;

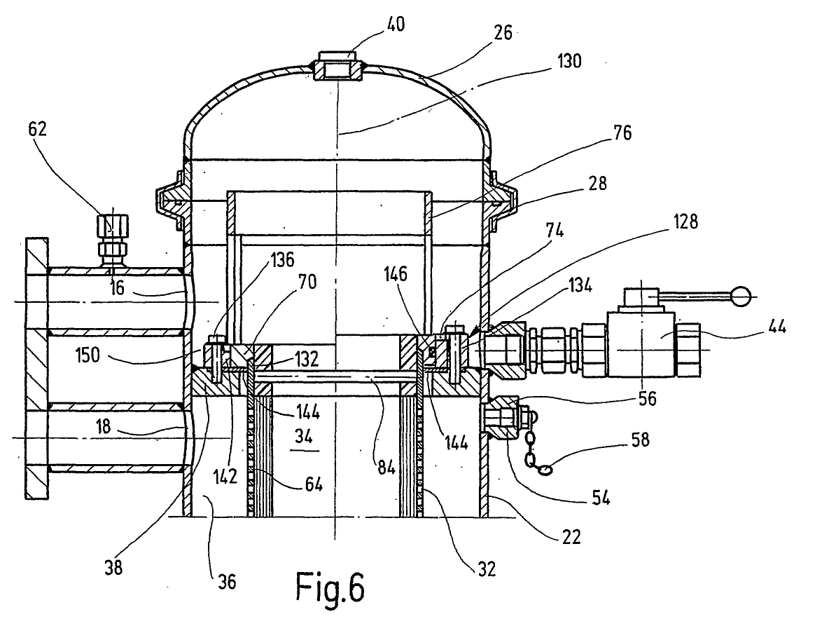

FIG. 6 shows the top end of the filter device with two supporting body arrangements which are used differently;

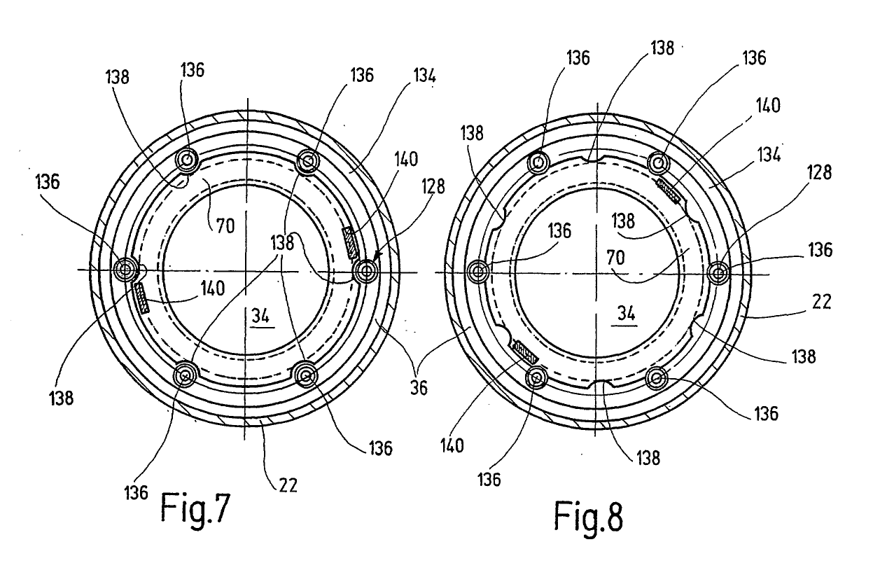

FIGS. 7 and 8 show an overhead view of the quick release connecting means between the filter element and the filter housing, once in the released and once in the locked position.

The filter arrangement shown in FIG. 1 consists essentially of two interacting filter devices which can be triggered by way of a change-over fitting 10 which is located between the two filter devices. The change-over fitting 10 consists essentially of two ball valves 12 which are located on top of one another and which can be moved by way of a common control shaft 14, for example manually. In the drawing shown in FIG. 1 the ball valves 12 of the change-over fitting 10 assume an operating position such that from the outside fouled fluid travels by way of the inlet 16 into the filter device and the cleaned fluid flows by way of the outlet 18 back to the change-over fitting 10 and is routed there by way of the ball valve 12 which is the lower one as seen in the line of sight to FIG. 1, for further use, for example in a hydraulic or machine system.

In the illustrated operating position of the change-over fitting 10, as seen in the line of sight to FIG. 1 the right filter device is started, whereas the opposite left filter device is kept in stand-by operation. If a filtration process is no longer possible with the right filter device, for example due to the contamination which has been increasingly filtered out, by actuating the change-over fitting 10 the ball valves 12 can be moved into the other operating position and the other left filter device is then activated, whereas the right filter device which had been used for filtration previously is turned off. The pertinent alternating operation can be time-controlled or in the pressurized lines a fouling indicator 20 can be connected to the change-over fitting 10; it monitors the fouling situation in the filter device which is operating at the time and then for example induces automatic switching.

The respective filter device itself consist essentially of a filter housing 22 with a filter housing bottom 24 and a filter housing cover 26. Otherwise the filter housing 22 is made essentially as a hollow cylinder and the filter housing bottom 24 is preferably connected to the filter housing 22 by a weld. The filter housing cover 26 in turn is detachably connected to the filter housing 22 by way of a quick action locking ring 28. For engagement of the quick action locking ring 28 both the adjacent ends of the filter housing 22 and also of the filter housing cover 26 have conically tapering clamp surfaces over which the quick action locking ring 28 can extend with its V-shaped receiving cross section. The pertinent quick action locking ring 28 can be tensioned by way of the clip 30 and fixed and released by hand. Within the filter housing 22 a filter element 32 is fixed; its detailed structure is shown in FIGS. 2 to 4. For the filtration process in any case flow takes place through the filter element 32 from inside 34 to outside 36, the pertinent fluid flow directions as seen in the line of sight to FIG. 1 being represented by arrows on the right side.

Between the inlet 16 and the outlet 18 of each filter device a support ring 38 is pulled in which keeps the filter element 32 in the middle within the filter device and otherwise separates the inlet 16 from the outlet 18 fluid-tight from one another within the housing 22. Additionally, the filter system as shown in FIG. 1 has a host of fluid valves in the form of ball valves which are used in part for venting and in part for emptying the device. Thus the right filter device as shown in FIG. 1 on the top of the filter housing cover 26 has a vent screw 40 for the contaminated side. As shown by the left filter device from FIG. 1, it can also be replaced by a ball valve 42 for the contaminated side. Between the inlet 16 and the outlet 18 directly above the support ring 38 there is a ball valve 44 for emptying the contaminated side in the housing cover area of the device. On the filter housing bottom 24 in each filter device on the clean side, i.e., between the filter element 32 and the inside wall of the filter housing 22, there is a ball valve 46 for emptying the clean side.

With the filter element 32 in place, moreover inserted into the filter housing 24 and connected to the inside 34 of the filter element 32 there is another ball valve 48 which is used to empty the contaminated side, if the interior 34 of the filter element 32 is considered. Alternatively it can also be provided that instead of the ball valve 48 and ball valve 44 there can be common tubing 50 which can then be triggered appropriately by way of a common ball valve 52. For venting the clean side, underneath the support ring 38 in the filter housing 22 there is a vent point 54 which is sealed shut by the sealing cap 56. The respective sealing cap 56 is connected by way of a safety chain 58 to the clip 30 of the quick action locking ring 28 so that on the one hand the sealing cap 56 cannot be lost, on the other however it is also ensured that only after venting the clean side in the filter housing 22 by way of the vent point 54 can the quick action locking ring 28 be opened by way of the clip 30. This represents a safety measure for the maintenance personnel charged with changing the element.

For the double filter arrangement as shown in FIG. 1 the respective filter device with its filter housing 22 is set up by way of stands 60. Otherwise the two filter devices correspond to one another. In order to ensure restarting of the respective filter device after changing the filter element, there is a fill line 62 by way of which the corresponding filling is possible into the feed line to the respective inlet 16 upstream and downstream of a change-over fitting 10.

The actual filter element 32, as is shown in FIG. 4, on the outer periphery side has a supporting body 64. The supporting body 64, as is shown in particular in FIG. 3, forms the so-called support tube for the filter mat body 66, as is shown in detail in FIG. 2. The supporting body 64 is made perforated, i.e., is provided with passages 68 for passage of the cleaned fluid out of the filter element 32. Towards the ends the supporting body 64 is elongated in the manner of a sleeve and on its top end is welded to a bearing ring 70 and on its other bottom end is likewise connected in this way to the bottom part 72 of the support body.

In the embodiment of a supporting body 64 as shown in FIGS. 3 and 4, the bearing ring 70 is provided with a flange-like widening 74. Furthermore, on the top of the bearing ring 70 there is a removal handle 76 which to that end is welded to the bearing ring 70. The removal handle 76 is preferably made in one piece and to the inside borders a wide cavity which is suitable for replacing the filter mat body 66 by way of the middle of the handle which remains open. For this reason the removal handle 76 can preferably be made in the manner of a hollow cylinder. Additionally, the height of the handle is chosen to be such that in any case the free end of the removal handle 76 runs into the separating area between the filter housing cover 26 and the remaining filter housing 22 in order to enable removal of the filter element 32 from the filter housing 22 with the cover 26 removed, without hindrance. The bottom part 72 of the supporting body 64 which is welded securely to the latter in the middle has an outlet point 78 which is provided with an annular seal 80 relative to the bottom part 72 of the supporting body.

The filter mat body 66 itself consists preferably of a pleated filter mat with filter cloth layers which filter out contaminants from the fluid running through the filter device, the dirt remaining in the filter mat body 66. The free end of the filter mat of the filter mat body 66 is bordered by a plastic sealing compound 82 in which a semicircular handle 84 is integrated which can be folded up out of its position shown in FIGS. 2 and 4 to enable maintenance personnel to pull the filter mat body 66 without further loosening of fasteners or the like out of the supporting body 64 and thus to remove it. The bottom of the filter mat body 66 is formed by a receiving part 86 with free ends which are upright in the manner of a fixing ring 88, and which point to the interior of the filter mat body 66. On the outside of the fixing ring 88 it is in turn permanently joined to the bottom end of the filter mat of the filter mat body 66 by means of the plastic sealing compound 82. The receiving part 86 furthermore has a retainer 90 which projects into the interior of the filter mat body 66 and which is provided on its free end with crimping 92.

Within the crimping 92 a compression locking spring 94 as an energy storage device with its one free end fits into the free space of the retainer 90 which has been formed in this way. On its other free end the compression locking spring 94 is in contact with a closing ball 96 as the closing body or closing element of the sealing device which is labelled 98 as a whole (compare FIGS. 4 and 5). Instead of the indicated closing ball 96 other forms of a closing body are also conceivable. Furthermore, instead of the illustrated closing ball-compression locking spring arrangement for the sealing device 98 a plate valve or the like could also be used. So that the closing ball 36 cannot emerge from the retainer 90, the latter as protection against loss has an offset 100 with retaining surfaces on which the closing ball 96 comes to rest essentially in a line when the filter mat body 66 is removed from the supporting body 64 and the compression locking spring 94 keeps the closing ball 96 in its frontmost position, as shown in FIG. 2.

Viewed in the lengthwise direction of the retainer 90, the latter has between the offset 100 and the crimping 92 passages 102 which are otherwise bordered in the peripheral direction by the rods of the retainer 90. The pertinent passages 102 are used for passage of the contaminated fluid from the interior of the filter mat body 66 into the interior of the retainer 90 in which the closing ball 96 is captively held to move lengthwise against the action of the compression locking spring 94. Preferably, for reasons of better disposability of the filter mat body 66, the retainer 90 and the closing ball 96 are made of plastic materials. Preferably the compression locking spring 94 can also consist of plastic material, but in this case, however, the spring material consists of a steel material to ensure high closing forces.

If, in the process of preparing a filter element 32, the filter mat body 66 is pushed into the support body 64 from overhead, specifically by way of the open middle of the removal handle 76, the outer peripheral side of the filter mat slides along the inside of the supporting body 64 and when the filter mat body 66 has been fully inserted, as is shown in FIG. 4, the supporting body 64 to the outside forms a support for the filter mat in fluid and filtering operation. In the fully inserted state then the receiving part 86 adjoins the top of the bottom part 72 of the supporting body together with the bottom sealing compound 82. To ensure that air cushions which may be trapped between the bottom of the filter mat body 66 and the bottom part 72 of the supporting body cannot hinder the insertion or removal process, the bottom part of the supporting body has through vent openings 104.

In the pertinent installation state the closing ball 96 is raised somewhat from its assigned offset 100, but held in line contact by way of the compression locking spring 94 on the annular seal 80 of the bottom part 72 of the supporting body so that in this way a fluid-tight seal for the sealing device 98 is achieved by way of the closing ball 96.

The lengthwise dimensions of the filter mat body 66 and the supporting body 64 are chosen relative to one another such that the sealing compound 82 on the top of the filter mat body 66 ends flush with the handle 84 and with the top of the bearing ring 70. If the filter element 32 is composed of the filter mat body 66 and the supporting body 64 as shown in FIG. 4, the pertinent filter element 32 can be inserted into the filter housing 22 with the filter housing cover 26 removed.

An opening part 108 is inserted into the filter housing bottom 24 in the middle as an element receptacle 106. The opening part 108 has an engagement nozzle 110 which fits with its free end into the retainer 90 when the filter element 32 has been fully placed on the element receptacle 106, and forces the closing ball 96 with pretensioning of the compression locking spring 94 back in the direction of the crimping 92. For this reason the engagement nozzle 110 on the inner peripheral side on its free end has a conically peripheral engagement surface 112 which allows calibration of the closing ball 96 in the engagement nozzle 110. The engagement nozzle 110 is in turn made in the manner of a cage and distributed on the peripheral side has passages 114. The passages 114 end in the cylindrical engagement area 116 of the engagement nozzle 110, the pertinent engagement area 116 extending completely through the outlet point 78 in the bottom part 72 of the supporting body when the filter element 32 has been fully placed on the element receptacle 106, and on the outer peripheral side is sealed in contact with the annular seal 80.

In the area of the filter housing bottom 24 the opening part 108 has a flange-like widening and is sealed in contact with the top of the filter housing bottom 24 by way of a flat seal 118. On the opposite side, i.e., on the bottom end of the filter housing bottom 24, the opening part 108 has an outside thread 120 onto which the union nut 122 can be screwed in order to fix the opening part 108 in this way to form a seal within the through hole 124 of the filter housing bottom 24. On the bottom of the opening part 108 for the filter element 32 then the ball valve 48 for emptying the contaminated side or the tubing 50 follows (compare FIG. 1).

As FIG. 5 furthermore clearly shows, when the filter element 32 has been fully placed on the element receptacle 106, between its flange-like widening and the bottom of the bottom part 72 of the supporting body there is still an axial distance. As the partial representation in FIG. 5 furthermore shows, the contaminated fluid present within the filter element 32 with the closing ball 96 pressed on is relayed by way of the opening part 108, by way of the passages 102 and 114 in the retainer 90 or in the opening part 108 and by way of a channel-like fluid drain 26 to the ball valve 48 or by way of the tubing 50 of the alternative embodiment to the common ball valve 52. The pertinent ball valves 48, 52 are closed in operation of the filter device, just like the ball valves 46 for emptying the clean side of the filter device.

To fix the filter element 32 within the filter housing 22 a quick release connecting means identified as a whole by 128 and designed as a type of quarter-turn fastener is used. The details are shown in FIGS. 6 to 8. As seen in the line of sight to FIG. 6 on the left and right from the lengthwise axis 130 of the filter device two different embodiments of the pertinent quarter-turn fastener are shown. The embodiment which on the left as seen in the line of sight to FIG. 6 relates to a filter device 32 as is shown in FIG. 4. Here the bearing ring 70 of the supporting body 64 is provided on its bottom with an annular recess which borders a type of sealing edge 132 to the outside. On the top of the support ring 38 which is welded to the interior of the filter housing 22 a spacer ring 134 is fixed by way of individual screws 136. The height of the spacer ring 134 is chosen to be slightly greater than the assigned height of the bearing ring 70 of the supporting body 64. Furthermore, the bearing ring 70 on its side facing the screws 136 has concave recesses 138, as many as there are screws 136. Additionally, the diameter ratios between the recesses 138 and the screws 136 are chosen accordingly, i.e., the heads of the screws 136 fit with radial play into the recesses 138, if the filter element 32 is inserted from overhead into the device with the filter housing 22 with the filter housing cover 26 lifted off.

The pertinent engagement situation is shown in FIG. 7; it represents an overhead view with the housing cover 26 lifted off and the filter element 32 inserted into the remaining filter housing 22. The pertinent representation as shown in FIG. 7 also corresponds to the removal position for the filter element 32 if, having become unusable, it is to be replaced by another. Furthermore, the bearing ring 70, as shown in FIGS. 7 and 8, on the top can have stops 140 which are diametrically opposite one another and which in pairs to one another maintain a distance which corresponds at least to the diameter between two screw pairs 136 which are diametrically opposite one another, in the region of the head areas which face one another adjacently. In this way it is ensured that with the filter element 32 inserted and the bearing ring 70 twisted by way of the removal handle 76 counterclockwise out of the position shown in FIG. 7 into the one shown in FIG. 8 the screw heads 136 securely hold the bearing ring 70 in the locked position by the heads of the screws 136 extending partially over the pertinent bearing ring and the stops 140 which are then in contact with the assigned screw pairs 136 preventing stripping and repeated loosening in the sense of FIG. 7. To ensure that the bearing ring 70 on the spacer ring 134 is guided for rotary motion in this way, the spacer ring 134 on its side facing the bearing ring 70 has a shoulder 142 which is used to support the flange-like widening 74 of the bearing ring 70.

Between the bearing ring 70 and the support ring 38 there is a stripper ring 144 which is likewise fixed by way of screws 136 on the support ring 38. The stripper ring 144 has a diameter such that it is elastically in contact with the outside of the supporting body 64 with an assigned contact pressure on the outer peripheral side. This ensures that when the filter element 32 is removed contamination which has remained on the outside periphery of the supporting body 64 is scraped off by way of the stripper ring 144 and remains within the housing 22. In the embodiment shown on the left as seen in the line of sight to FIG. 6 the pertinent stripper ring 144 also assumes a sealing function from the inlet to the outlet 18 of the filter device by the sealing edge 132 of the bearing ring 70 in the fixed state fitting from overhead into the stripper ring 144.

The pertinent sealing is promoted by the pressure conditions within the filter device. In conventional filtering operation with the filter element 32 inserted, specifically on the side of the inlet 16 of the filter device there is increased pressure which presses the filter element 32 and moreover the sealing edge 132 down and thus ensures sealing. Accordingly it is irrelevant if between the spacer ring 134 and the bearing ring 70 there is a certain play over the adjustable length of the screws 136; this facilitates connection by way of the quick release connecting means 128 since the pertinent distance is equalized by sealing by way of the filtration pressures within the device.

In the embodiment which is the right one as seen in the line of sight to FIG. 6, the filter element 32 has no sealing edge 132, but rather the bearing ring 70 on its bottom is made plane, in contrast to the representation in FIGS. 2 and 4, however has an outside groove 146 with a sealing O ring. The fluid-tight sealing relative to the inner periphery of the spacer ring 134 which is provided in turn with a shoulder 142 for contact with the flange-like widening 74 of the bearing ring 70 takes place by way of the pertinent O ring in the outside groove 146. Since moreover sealing no longer takes place by way of the stripper ring 144, between the top of the stripper ring 144 and the bottom of the bearing ring 70 there can be an axial distance in the direction of the lengthwise axis 130 of the filter device. Instead of the bridge-like removal handle 76 for the filter element 32, there can also be a removal clip 148 as is shown in FIG. 1 for the right filter device as one alternative embodiment in the left half of the figure, therefore to the left of the lengthwise axis 130 of the right filter device. The pertinent removal clip 148 could also be folded down, similar to the clip-like handle 84 for the filter mat body 66. But preferably the handle 84 of the filter mat body 66 is made as a holding bar which extends in the middle through the filter mat body 66 and is held on the end side in the plastic sealing compound 82.

Furthermore, it can be provided as in one modified embodiment that the supporting body 64 be left directly in the filter device and only the filter mat body 66 as the filter element be replaced. In the pertinent case, preferably between the closing ball 96 as the closing element and the bend 100 of the retainer 90 sealing may be provided directly, for example by the offset 100 being provided with sealing means. As furthermore shown in FIG. 6, between the inside of the housing 22 in the area between the inlet 16 and outlet 18 and the outside of the spacer ring 134 a contaminant channel 150 is formed in which residual amounts of fluid which are contaminated can collect when the filter device is shut down and which then can be removed from the device by way of the ball valve 44 as the emptying point for the contaminated side by the pertinent removal of the ball valve 44 discharging directly into the contaminant channel 150 above the support ring 38 into the interior of the filter device.

To better understand the filter device as claimed in the invention, at this point changing of the filter element is detailed using the device and the figures. As shown in FIG. 1, seen in the line of sight, the left filter device is shut down and filtering operation is carried out with the right filter device. If after a certain interval of filter use the filter element 32, especially the filter mat body 66, is fouled, the pertinent element should be replaced. Optionally, by way of measuring the difference pressure by means of the fouling display 20 the pertinent degree of fouling which necessitates replacement of the element can be established. To shut down the right filter device of the double filter shown in FIG. 1, moreover switching of the ball valves 12 of the change-over fitting 10 is necessary. After switching, the left filter device is then in operation and the right filter device is shut down, but filled however with contaminated fluid. Accordingly, the so-called contaminated side of the filter device should be emptied first of all for changing the element of the filter element 32.

This takes place by opening the ball valves 44 and 48 which represent one emptying possibility for the contaminant side. Here the contaminated fluid is emptied toward the cover side of the filter housing 22 by way of the ball valve 44 and the interior 34 of the filter element 32, which is likewise filled with contaminated fluid, is emptied by way of the ball valve 48 located right at the bottom (or for the other filter device by way of the ball valve 52). The latter emptying takes place by way of the sealing device 98 which for the pertinent emptying process according to the representation in FIG. 1 and FIG. 5 by way of the opening part 108 is in its opened fluid-carrying position. Then venting takes place on the cover side of the filter housing 22 by way of the vent screw 40 in the upper area of the filter housing cover 26. Alternatively, as is shown in FIG. 1, the pertinent venting can also take place on the contaminant side by way of the ball valve 42 shown there so that the vent screw 40 can also be omitted in the pertinent approach. Accordingly, then the clean side is emptied by way of opening the ball valve 46 which discharges onto the clean side 36 of the filter device. Furthermore, the pertinent clean side can then be vented accordingly at the vent point 54 by removing the sealing cap 56.

To remove the fouled filter element 32 then it is necessary to open the quick action locking ring 28, which is possible by means of the clip 30 only when venting has taken place on the clean side by way of the vent point 54, since otherwise the safety chain 58 in the vicinity of the vent point 54 would make the pertinent opening process by way of the clip 30 impossible. This is used for the safety of the maintenance personnel. Lifting of the filter housing cover 26 under pressure and unintentionally is therefore prevented in this way. As soon as the filter housing cover 26 is removed, the filter element 32 is swivelled by way of the removal handle 76 out of its fixed position shown in FIG. 8 clockwise until the removal position as shown in FIG. 7 is established. In the pertinent removal position the recesses 138 are congruent with the screws 136 and thus a raising motion of the filter element 32 is possible. With removal of the filter element 32 the opening part 108 is removed from the retainer 90 and the compression locking spring 94 moves the closing ball 96 into sealing contact with the annular seal 80 of the bottom part 72 of the supporting body. Conversely then the interior 34 of the filter element 32 is fluid-tight relative to the environment by way of the sealing device 98, i.e., sealed almost drip-proof.

After the significant remaining amount of fluid in the interior 34 of the filter element 32 has been drained by way of the sealing device 98 and the assigned emptying ball valve 48 and 52, the remaining contamination essentially consists of contaminated drops which emerge from the filter mat body 66. They are retained at this point by way of the sealing device 98 in the interior 34 of the filter element 32 and cannot pollute the environment. Then, as was detailed in FIGS. 2 to 4, the filter mat body 66 is separated from the supporting body 64 and disposed of accordingly and replaced by a new filter mat body 66. Furthermore, it is possible to clean the supporting body 64 appropriately. When the fouled supporting body 64 is removed, contamination remaining on its outside can be removed by way of the stripper ring 144 so that the pertinent contamination cannot emerge unintentionally from the filter device.

Finally, the filter element 32 which has been replaced in this way is re-inserted in the reverse sequence and fixed in the filter device by way of a quarter-turn fastener. The sealing device 98 assumes its open position again, as is shown in FIG. 5. After re-mounting the filter housing cover 26 which in turn is fixed by way of the quick action locking ring 28 with the clip 30, start-up of the filter device begins by venting and filling. In doing so, first the ball valves 44, 46 and 48 are closed accordingly on the clean and also the contaminant side. Then the fill line 62 for filling the filter housing 22 is opened. The vent point 54 is closed and then the vent screw 40 is screwed in or alternatively the ball valve 42 is closed. Accordingly, both a closing process for venting on the clean side and also on the contaminant side has taken place. After closing the fill line 62, in turn by actuating the change-over fitting 10 and moving the ball valves 12 into the operating position as show in FIG. 1 the filter device which is the right one as seen in the line of sight to the figure can be started and the left one shut down. The latter is then available, as shown, for a cleaning process. To further relieve the maintenance personnel during maintenance, it can be provided that the filter housing cover 26 be made as a dished head in order achieve a reduced-weight, overall structure for the filter device.

1. A filter device with at least one filter element (32) which can be accommodated in a filter housing (22), with an inlet (16) for the fluid to be cleaned and an outlet (18) for the fluid which has been cleaned by the filter element (32), the filter element (32) being held by at least one element receptacle (106) of the filter housing (22), with the removal of the filter element (32) from the element receptacle (106) a sealing device (98) sealing the interior (34) of the filter element (32) to the environment, the sealing device (98) having a closing element which is pressed against the element receptacle (106) in the installed state of the filter element (32) under the action of an energy storage device in the direction of its closed position, the closing element being guided in a retainer 90 of the filter element (32), as a further part of the sealing device (98) the filter housing (22) having an opening part (108) which holds the closing element against the action of the energy storage device in the direction of its open position when the filter element (32) has been placed on the element receptacle (106), and the opening part (108) having a fluid drain (126), characterized in that for fluid supply of the fluid drain (126) both the retainer 99) and also the opening part (108) have passages (102, 114) for the fluid located in the interior (34) of the filter element (32).

2. The filter device as claimed in claim 1, wherein the closing element is a closing ball (96) which is under the action of a compression spring (94) as the energy storage device and which, held together with the closing ball (96) in the retainer (90), is a component of the bottom (24) of the filter element (32), which component projects into the interior of the filter element (32).

3. The filter device as claimed in claim 1 or 2, wherein the opening part (108) is made annular and is connected to the filter housing bottom (24) and wherein the fluid drain (126) discharges into the shut-off valve (48, 52).

4. The filter device as claimed in claim 1 to 3, wherein the retainer (90) has retaining surfaces (100) for the closing element and wherein in the closed position of the sealing device (98) the closing element separates the respective passage (102) of the retainer (90) from the respective passage (114) of the opening part (108).

5. The filter device as claimed in claim 4, wherein the filter element (32) has a supporting body (64) and a filter mat body (66) which can be separated from one another and wherein the sealing device (98) is at least partially a component of the filter mat body (66).

6. The filter device as claimed in one of claims 1 to 5, wherein the filter housing (22) has a support ring (38) for the filter element (32) which can be detachably joined to the filter housing (22) by way of a quick release connecting means (128).

7. The filter device as claimed in claim 6, wherein the support ring (38) is provided with a stripping means (144) which when the filter element (32) is removed scrapes along its outside periphery.
